(19) United States
(12) Patent Application Publication
(10) Pub. No.: US 2026/0340207 A1
(43) Pub. Date: Oct. 29, 2026

(54) METHOD OF GENERATING A COMPONENT INCLUDING A BLENDED LATTICE

(71) Applicant: Siemens Industry Software Inc., Plano, TX (US)

(72) Inventors: James Gunton, Cambridge (GB); Matthew Goddard, Royston (GB)

(21) Appl. No.: 19/109,076

(22) PCT Filed: Nov. 10, 2022
(86) PCT No.: PCT/US2022/049562

§ 371 Date: Mar. 5, 2025

(30) Foreign Application Priority Data
Sep. 30, 2022 (WO) PCT/US2022/045344

(51) Int. Cl. G06F 30/10; G06F 111/10

(52) U.S. Cl. CPC G06F 30/10; G06F 2111/10

(57) ABSTRACT

A computer-implemented method of generating a model of a component from a blended lattice is described. The method includes evaluating a piecewise scalar field function for a blended lattice h(p) as part of a marching cubes methodology. Away from any blends, ƒ(p)=0 and g₂(p)=0 are the same iso-surface, and away from any convex blends, g(p)=0 and g₂(p)=0 are the same iso-surface, where ƒ(p) is the field function of an unblended lattice, g(p) is the field function of a blended lattice, and g₂(p) the field function of a double-blended lattice. The method further includes generating a model of a component including the blended lattice with the piecewise scalar field function h(p).

The present patent document is a § 371 nationalization of PCT Application Serial No. PCT/EP2022/049562, filed Nov. 10, 2022, designating the United States, and this patent document also claims the benefit of PCT Application Serial No. PCT/US2022/045344, filed Sep. 30, 2022, which are hereby incorporated by reference in their entireties.

### TECHNICAL FIELD

The present disclosure relates to a computer-implemented method of generating a model of a component from a blended lattice, wherein the blended lattice includes a plurality of lattice topologies joined together.

### BACKGROUND

Computer-Aided Design (CAD) systems are used commonly in many fields of engineering, manufacturing, and design to create and manipulate solid modelling representations of objects, for example, in additive manufacturing. Boundary representation (B-rep) technology dominates CAD modelling. The B-rep technology provides an efficient and adaptable representation of parts by combining classic geometry: analytic surfaces and curves, non-uniform rational basis spline (NURBS) and procedural surfaces and curves; with topology, which captures the connectivity and interaction between geometric elements. Additive manufacturing is the process of creating three-dimensional objects using a three-dimensional printer based on CAD or other digital three-dimensional models. Objects may be scanned as a precursor to creating a CAD model, or may be designed from scratch, and stored in either STL (stereolithography file format) or AMF (additive manufacturing file format) files for future printing. Lattices are a common type of interior space-filler used in additive manufacturing as their lightweight, yet rigid construction makes them ideal for this purpose—the object is strengthened but its mass density remains relatively low. In B-rep (Boundary Representation) modelling, such spaces are enclosed by closed, connected sets of faces, where each face is a portion of a two-dimensional surface. The faces have boundary edges, which are defined by curves where the faces intersect with one another. Lattices include a plurality of lattice topologies, where a lattice topology is either a rod or a ball. Rods may be cylindrical or conical, and balls are spherical. Each rod is joined to other rods by a ball, building up the lattice structure.

Complex lattice structures may be used in heat transfer, filtration, and structural components for their energy absorption, mechanical strength, and other physical qualities, which have a broad range of application from automotive to medical technology sectors. One particular issue with a lattice structure however is the occurrence of stress at the points where the rods and balls intersect. This may be caused by a sharp, concave edge being generated in the lattice surface. Stress points are problematic as they lead to issues with the lattice structure deforming or even breaking apart in a final component. For example, if the intersection between a rod and ball is a region of high stress, then little mechanical strength or pressure will be required to cause the lattice to break at the intersection. One solution to this is to create a blended lattice structure, where intersections between rods and balls within the lattice have a smoothed surface, thus removing concave sharp edges and the origin of regions of stress. An example of a blend is shown in FIG. 1a, which is a schematic perspective view of four rods joined at one ball with a blended surface. The four rods 1, 2, 3, 4 meet a ball 5, which is no longer seen due to the blended surface, which effectively obscures the intersection points between the rods 1, 2, 3, 4 and the ball 5. Between each adjacent pair of rods (1,2), (2,3), (3,4), (4,1) there are smooth blend surfaces 6, 7, 8, 9.

However, one issue with available blending applications is that too much material may be added at the intersection point, leading to bulging. This is illustrated in FIG. 1b, which is a schematic perspective view of four rods joined at one ball with a bulged blended surface. Rather than the blend surfaces 6, 7, 8, 9 being in the plane of the long axes of the rods 1, 2, 3, 4 seen in FIG. 1a, a significant bulge 12 is visible at the intersection point. This causes the box size, in model space, of the incarnated blended lattice to be greater than the box size of the incarnated unblended lattice, which may (i) create interference problems when incorporated into an assembly containing other components, and (ii) cause the calculation of the box to be more computationally intensive. Additional material is added to flat or convex surfaces, whereas the region of interest for smoothing is the sharp concave edges between lattice topologies.

A second issue is the freedom of a user to select the level of blending at each lattice intersection. Blending is specified using a blend radius, which is a value representing the amount of material added at each intersection point. The blend radius in existing blending applications is constant, such that the same blend is applied at every intersection point of the lattice. However, in some applications it may be necessary to add differing amounts of material depending on the desired characteristics of the final model or product. For example, a heat sink may need different thermal properties in different locations, or a component may require different mechanical strengths in certain areas. Such options are not possible without being able to change the blend radius at different positions in the lattice.

Therefore, there is a need for an improved method of generating a component from a blended lattice that takes into account the issues encountered by bulging, constant radius blends.

### SUMMARY

The present disclosure aims to address these issues, by providing, in a first aspect, a computer-implemented method of generating a model of a component from a blended lattice, wherein the blended lattice includes a plurality of lattice topologies joined together, at least some of the joins being a combination of a concave blend and a convex blend. The method includes dividing a volume containing an input lattice into a plurality of cubes, each cube forming a voxel of side length v. The method further includes evaluating h(p) over the volume for each value of a position p occurring at a corner of a cube, wherein h(p) is a piecewise scalar field function for a blended lattice; wherein a surface of an unblended lattice is defined by a field function ƒ(p), a surface of a blended lattice for a concave blend is defined by a field function g(p) and a surface of a double-blended lattice for a combination of a concave blend and a convex blend is defined by a field function g₂(p), wherein away from any blends ƒ(p)=0, g₂(p)=0 are the same iso-surface and away from any convex blends g(p)=0 and g₂(p)=0 are the same iso-surface, and wherein the value of h(p) at a position p where for two closest lattice topologies i₁, i₂, ƒ₁(p) and ƒ₂(p) satisfy ƒ₁(p)≤ƒ₂(p) is given by:

h(p)=ƒ(p) if ƒ₁(p)≤−v;

h(p)=ƒ(p) if ƒ₂(p)≥2r+v;

h(p)=ƒ(p) if ƒ₁(p)+ƒ₂(p)≥2r and ƒ₁(p)≥v;

h(p)=g(p) if g(p)≥v;

h(p)=g(p) if g(p)≤−s and g(p)≤−v;

h(p)=g₂(p) otherwise;

where r is a concave blend radius and s is a convex blend radius. The method further includes generating a model of a component including a blended lattice with the scalar field function h(p).

By integrating a piecewise calculation of the scalar field function h(p) for a blended lattice into a marching cubes approach and making use of the ability to equate h(p) to the field function for an unblended lattice ƒ(p) for values of position p outside of a boundary set by the voxel resolution v and the blend radius r, the embodiments offer an accurate blending process that avoids adding additional material in flat or convex regions. In addition, the need to determine the field functions g(p) or g₂(p) in the blend region for only a small number of values of position p and relying on the faster calculation of the unblended lattice field function ƒ(p) reduces the calculation time, thus providing a more controllable final component in a manufacturing or design process in a shorter time. By using a double-blended field function g₂(p) as part of the piecewise calculation, a convex blend may be applied to a concave blend to reduce the occurrence of sharp edges and points that would otherwise occur where two concave blends intersect, or where a single concave blend is self-intersecting.

Each lattice topology i may be a rod or a ball.

The field function of the unblended lattice ƒ(p) may be given by:

$$f ( p ) = {min}_{1 \leq i \leq N} {f}_{i} ( p )$$

where ƒ₁(p) is the signed distance from the position p to the surface of a lattice topology i, and N is the number of lattice topologies in the lattice; and wherein the field function of the blended lattice g(p) is given by:

$$g ( p ) = {max}_{- ‖ q - p ‖ \leq r} ( f ( q ) - r )$$

where q is a position within the volume of a sphere of radius r centered at p; and wherein the field function of the double-blended lattice is given by:

$${g}_{2} ( p ) = {min}_{‖ c - p ‖ \leq s} ( {max}_{‖ q - c ‖ \leq r + s} ( f ( q ) - r ) )$$

where q is a position within the volume of a sphere of radius r+s centered at c and c is a position within the volume of a sphere of radius s centered at p.

The evaluation of:

$$f ( p ) = {min}_{1 \leq i \leq N} {f}_{i} ( p )$$

may be stopped at a value of i where ƒᵢ(p)≤−v.

The evaluation of:

$$g ( p ) = {max}_{\vert \vert q - p \vert \vert \leq r} ( f ( q ) - r )$$

may be stopped at a value of q where ƒ(q)−r≥v.

If the value of h(p′) has already been calculated at a position p′, the value of h(p) may be set to a lower bound:

h_{lower}=h(p′)+min(−∥p−p′∥,r(p′)−rₘₐₓ,sₘᵢₙ−s(p′)

if h_{lower}≥v, or to an upper bound

hᵤₚₚₑᵣ=h(p′)+max(∥p−p′∥,r(p′)−rₘᵢₙ,sₘₐₓ−s(p′))

if hᵤₚₚₑᵣ≤−v.

In one option, g(p) and the corresponding position q may be determined exactly. Alternatively, g(p) and the corresponding position q may be estimated. Yet further alternatively, g(p) and the corresponding position q may be determined by marching within the sphere.

The blend radius r may be constant over the lattice structure. Alternatively, the blend radius r may be a function of the position p.

The method may further include incarnating the blended lattice as a mesh surface prior to generating the model of the component. The method may further include exporting the model of the component to an additive manufacturing device and manufacturing the component.

In a second aspect, the present disclosure provides a data processing system configured to generate a model of a component from a blended lattice, wherein the blended lattice includes a plurality of lattice topologies joined together, at least some of the joins being a combination of a concave blend and a convex blend. The data processing system includes a processor configured to: divide a volume containing an input lattice into a plurality of cubes, each cube forming a voxel of side length v; evaluate h(p) over the volume for each value of a position p occurring at a corner of a cube, wherein h(p) is a piecewise scalar field function for a blended lattice; and generate a model of a component including a blended lattice with the scalar field function h(p); wherein a surface of an unblended lattice is defined by a field function ƒ(p), a surface of a blended lattice for a concave blend is defined by a field function g(p) and a surface of a double-blended lattice for a combination of a concave blend and a convex blend is defined by a field function g₂(p), wherein away from any blends ƒ(p)=0, g₂(p)=0 are the same iso-surface and away from any convex blends g(p)=0 and g₂(p)=0 are the same iso-surface, and wherein the value of h(p) at a position p where for two closest lattice topologies i₁, i₂, ƒ₁(p) and ƒ₂(p) satisfy ƒ₁(p)≤ƒ₂(p) is given by:

h(p)=ƒ(p) if ƒ₁(p)≤−v;

h(p)=ƒ(p) if ƒ₂(p)≥2r+v;

h(p)=ƒ(p) if ƒ₁(p)+ƒ₂(p)≥2r and ƒ₁(p)≥v;

h(p)=g(p) if g(p)≥v;

h(p)=g(p) if g(p)≤−s and g(p)≤−v,

h(p)=g₂(p) otherwise;

where r is a concave blend radius and s is a convex blend radius.

The data-processing system may further include an output to a three-dimensional printing device.

In a third aspect, the present disclosure provides a computer program, which, when executed on a computer, causes the computer to carry out the acts of the method outlined above.

### BRIEF DESCRIPTION OF THE DRAWINGS

The present disclosure is now described by way of example only, and with reference to the accompanying drawings, in which:

FIG. 1a is a schematic perspective view of four rods joined at one ball with a blended surface;

FIG. 1b is a schematic perspective view of four rods joined at one ball with a bulged blended surface;

FIG. 2 is a flowchart of a method of generating a blended lattice, where a single blend function is used;

FIG. 3 is a schematic representation of two lattice topologies at a sharp concave edge;

FIG. 4 is a schematic illustration of a series of cross-sections of iso-surfaces of ƒ(p) and g(p);

FIG. 5 is a schematic representation of finding an exact maximum over a sphere;

FIG. 6 is a schematic representation of estimating a maximum over a sphere;

FIG. 7 illustrates the acts involved in a marching approach for estimating the maximum value over the sphere;

FIG. 8 is an illustration of the blending of two balls using a method in accordance with embodiments;

FIG. 9 which is an illustration of the blending of two balls using a method in accordance with embodiments;

FIG. 10 illustrates the piecewise field function h(p) of the blended lattice;

FIG. 11 is a flowchart of a method in accordance with an embodiment;

FIG. 12 is a flow chart of a marching method of estimating the value over the sphere;

FIG. 13 is an illustration of three different lattice configurations for which the value of k is zero;

FIG. 14 is an illustration of the blends of FIG. 13 in which the value of k is ⅓;

FIG. 15 is an illustration of the blends of FIG. 13 in which the value of k is ⅔;

FIG. 16 is an illustration of the blends of FIG. 13 in which the value of k is 0.95; and

FIG. 17 illustrates an example of a data processing system in which an embodiment of the present disclosure may be implemented, for example a CAD system configured to perform processes as described herein.

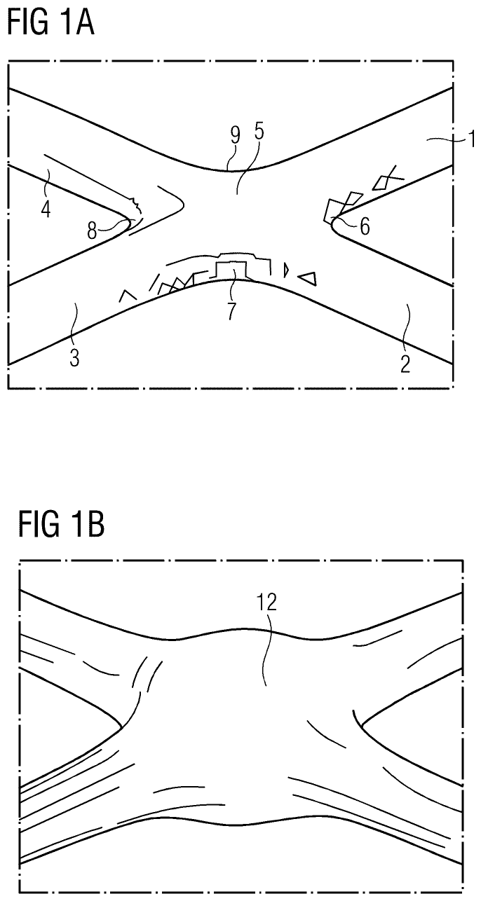

### DETAILED DESCRIPTION

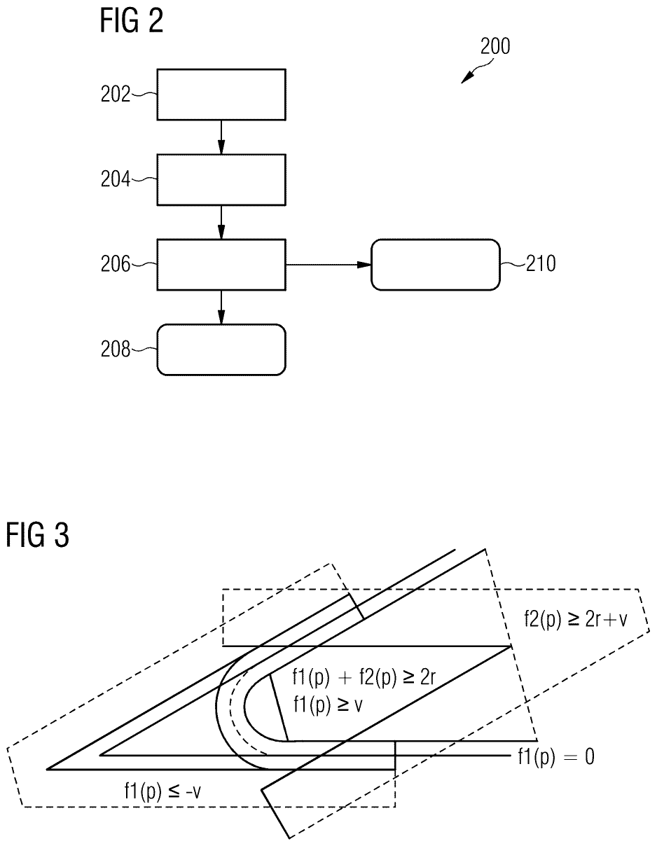

In order to provide background to the embodiments of the present disclosure, FIG. 2 is a flowchart of a method of generating a blended lattice, where a single blend function is used. The method 200 generates a model of a component from a blended lattice, where the blended lattice includes a plurality of lattice topologies joined together.

At act 202, the volume containing the input lattice is divided into a plurality of cubes, each cube (or “voxel”) having a side length v (the “voxel resolution”).

At act 204, h(p) is evaluated uniformly over the volume for each value of a position p occurring at the corner of a cube, where h(p) is the piecewise scalar field function for a blended lattice. The surface of an unblended lattice is defined by the field function ƒ(p) and the surface of a blended lattice is defined by the field function g(p). Away from any blends ƒ(p)=0 and g(p)=0 are the same iso-surface. The value of h(p) at a position p wherein for the two closest lattice topologies i₁, i₂, ƒ₁(p) and ƒ₂(p) satisfy ƒ₁(p)≤ƒ₂(p) is given by:

h(p)=ƒ(p) if ƒ₁(p)≤−v

h(p)=ƒ(p) if ƒ₂(p)≥2r+v

h(p)=ƒ(p) if ƒ₁(p)+ƒ₂(p)≥2r and ƒ₁(p)≥v

h(p)=g(p) otherwise,

where r is the blend radius.

At act 206, a model of a component is generated including a blended lattice with the scalar field function h(p). The method 200 may also include optional acts, depending on the purpose of the component.

At act 208, the blended lattice may be incarnated as a mesh surface prior to generating the model of the component.

At act 210, the model of the component may be exported to an additive manufacturing device and manufacturing the component.

The mathematical relationships above are represented schematically in FIG. 3, which is a schematic representation of two lattice topologies at a sharp concave edge. The acts of the method 200 are described in more detail below.

A blended lattice surface is defined by the scalar field function h(p)=0 for positions p, with h(p)<0 inside the lattice surface and h(p)>outside the lattice surface. Far enough from any blends, the scalar field function h(p) equals the field function of the unblended lattice, ƒ(p). Near the blends, h(p) equals a blended field function g(p), which is based on an offsetting function for constant radius blending described in “Blending Operations for the Functionally Based Constructive Geometry,” Alexander A, Pasko and Vladimir V. Savchenko, Set Theoretic Solid Modelling: Techniques and Applications, CSG 94 Conference Proceedings. For a lattice containing only sharp concave edges, blending takes place by offsetting the lattice outwards by the blend radius r, and then offsetting inwards, creating rolling-ball blends. The blend radius r may be a constant across the lattice, or a function of position that varies across the lattice. Embodiments of the present disclosure that deal with the generation of a component from a blended lattice with a constant blend radius r is now described.

### Unblended and Single Blended Field Functions

The field function representing the signed distance from a position p to the surface of a lattice topology i, such as a rod, is ƒᵢ(p), which has a value of 0 at the lattice topology surface and is positive outside the lattice topology surface and negative inside the lattice topology surface. The field function of the unblended lattice constructed as the union of N lattice topologies, ƒ(p), is given by:

$$f ( p ) = {min}_{1 \leq i \leq N} {f}_{i} ( p )$$

After blending with blend radius r, the blended field function g(p) is given by

$$g ( p ) = {max}_{\vert \vert q - p \vert \vert \leq r} ( f ( q ) - r )$$

where q is a position within the volume of a sphere of radius r centered at p.

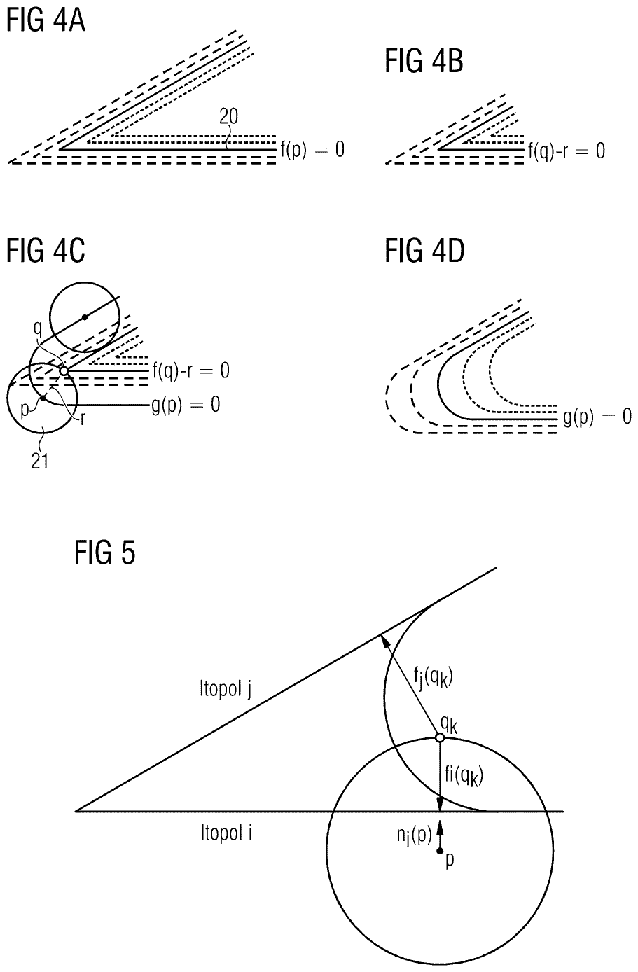

FIG. 4 is a schematic illustration of a series cross-sections of iso-surfaces of ƒ(p) and g(p). Each field function is positive outside of the lattice, zero on the surface of the lattice and negative inside the lattice. FIG. 4a illustrates the field function at ƒ(p)=0, where the central line 20 is the surface of the unblended lattice. FIG. 4b illustrates the situation where the field function minus the blend radius is zero, or ƒ(q)−r=0. The blend may be considered as a set of points traced out by the center of a solid ball 21 having a radius equal to the blend radius r, which is rolled around the inside of an offset lattice, where the offset lattice is the unblended lattice expanded by the blend radius r. The center of the ball represents the field function g(p)=0, and the surface of the ball 21 remains continuously in contact with the iso-surface at ƒ(q)−r=0, as shown in FIG. 4c. Finally, FIG. 4d illustrates the field function at g(p)=0. The function value equals the distance to the lattice surface only in some regions, for example, g(p) may be several times smaller than the distance to the blend surface when the unblended lattice has a very sharp edge. It is necessary to find the maximum value of ƒ(q)−r over the volume of the sphere (|q−p|≤r) rather than over the surface of the sphere (|q−p|=r). If at any point the maximum value over the surface is negative but the maximum value over the volume is positive, and only the surface maximum is used the blend surface will contain unwanted disconnected elements. This may only happen if the offset lattice contains void regions, which may occur even when the unblended lattice does not contain any void regions.

### Combining the Unblended and Blended Field Functions

Calculating the blended field function g(p) is slower than calculating the unblended field function ƒ(p), since this may require marching to find the maximum value. As mentioned above, away from any blended regions, both ƒ(p) and g(p) have the same iso-surface (where ƒ(p)=g(p)=0), hence it is possible to use ƒ(p) in these regions instead of g(p) to determine the scalar field function for the blended lattice h(p). This is possible at a position p wherein for the two closest lattice topologies i₁, i₂, ƒ₁(p) and ƒ₂(p) satisfy ƒ₁(p)≤ƒ₂(p) is given by:

h(p)=ƒ(p) if ƒ₁(p)≤−v

h(p)=ƒ(p) if ƒ₂(p)≥2r+v

h(p)=ƒ(p) if ƒ₁(p)+ƒ₂(p)≥2r and ƒ₁(p)≥v

h(p)=g(p) otherwise,

where r is the blend radius.

When using a marching cubes algorithm such that the entire lattice volume is divided into cubes, each cube (or “voxel”) has side length v (the “voxel resolution”). A spatial tree is used to efficiently find all of the lattice topologies within 2r+v of the position p. If fewer than two lattice topologies are found within this distance, then the condition for the second case for h(p) is met. If there are no lattice topologies, then h(p)=ƒ(p)>2r+v. Both ƒ(p) and g(p) are G⁰ continuous (where G⁰ is the first order of surface continuity such that two surfaces meet along a common edge forming a watertight boundary), but h(p) is not. However, none of the G⁰ discontinuities are within the voxel resolution of the blend surface, so they do not affect the blend surface.

### Approximating Field Values

The marching cubes algorithm estimates the position of the lattice surface by estimating the zero-crossing point along each cube edge, of length v, which connects a corner with a positive value to a corner with a negative value. The only positions p whose field values affect the position of the lattice surface are those that are within the voxel resolution v of the surface. Any other positions p may be given field values that bear little or no relation to h(p), as long as the values are ≥v outside the surface or ≤−v inside the surface. This allows the following performance improvements to be used:
1. the evaluation of

$$f ( p ) = {min}_{1 \leq i \leq N} {f}_{i} ( p )$$

may be stopped as soon as a lattice topology is found that satisfies ƒᵢ(p)≤v, such that p is sufficiently far inside the unblended lattice;
2. the evaluation of

$$g ( p ) = {max}_{\vert \vert q - p \vert \vert \leq r} ( f ( q ) - r )$$

may be stopped as soon as a point q is found that satisfies ƒ(q)−r≥v (such that p is sufficiently far outside the blended lattice);
3. if the value of h(p′) has already been calculated at a position p′, the value of h(p) may be set to a lower bound h_{lower}=h(p′)−|p−p′∥ if h_{lower}≥v or to an upper bound hᵤₚₚₑᵣ=h(p′)+∥p−p′∥ if hᵤₚₚₑᵣ≤−v.

For the last point to be true, it is assumed that |h(p′)| is no larger than the absolute distance d from p′ to the blended lattice, which is the case given that |ƒ(p′)|≤d and |g(p′)|≤d and given that |h(p′)| decreases by ∥p₂−p₁∥≥d₂−d₁ through successive uses of the lower or upper bounds.

### Finding the Exact Maximum Value Over the Sphere

The equations for ƒ(p) and g(p) may be rearranged to form the inequality:

$$f ( {q}_{k} ) - r \leq {max}_{\vert \vert q - p \vert \vert \leq r} ( f ( q ) - r ) \leq {max}_{\vert \vert q - p \vert \vert \leq r} ( {f}_{i} ( q ) - r )$$

for a particular sample point qₖ and lattice topology i.

The outer two values are easier to calculate than the middle value, g(p). If qₖ and i may be found so that the outer two values are equal, then this gives an exact value for g(p). For the lattice topology i, the right-hand value is:

$${max}_{\vert \vert q - p \vert \vert \leq r} ( {f}_{i} ( q ) - r ) = {f}_{i} ( {q}_{k} ) - r$$

with qₖ=p+rnᵢ(p),
where nᵢ(p) is the gradient of ƒᵢ(p), the normalized direction from the lattice topology i to position p if p is outside the lattice topology i, or in the reverse direction if p is inside.

The right-hand value equals the left-hand value if there are not lattice topologies closer to qₖ than the lattice topology i, in which case g(p)=ƒ(p). This is likely the case if the lattice topology closest to p is chosen. This is shown schematically in FIG. 5.

### Estimating the Maximum Value

By ignoring all lattice topologies except two, and by approximating those lattice topologies as planar, an estimate may be found for the blend spine positions s and the direction of steepest increase of ƒ(p). This is done using the distance to each lattice topology ƒ_{1,2}(p) and the field gradients of each lattice topology n_{1,2}(p), so long as the normal of the cross-section plane, N=n₁(p)×n₂(p), is not a zero vector. The spine s is the intersection of the two lines p+a_{1,2}+λt_{1,2}, where

t_{1,2}=n_{1,2}(p)×N

a_{1,2}=(r−ƒ_{1,2}(p))n_{1,2}(p)

The direction of steepest increase of ƒ(p) is

d=n₁(p)+n₂(p)

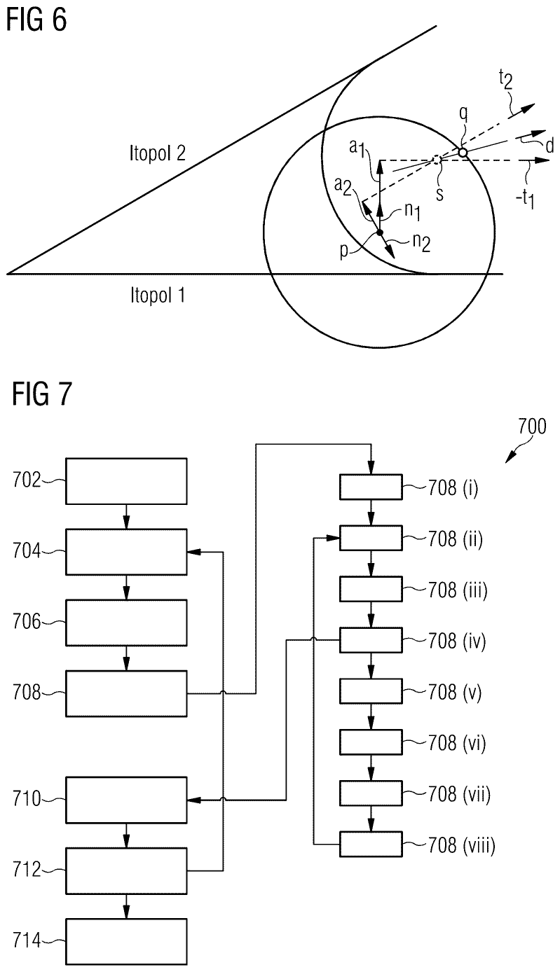

Intersecting the line s=μd with the sphere centered at p and using the solution with the larger d component, or using the closest approach if the line does not intersect the sphere, gives a position q. If the closest two lattice topologies to the position p are used, then the position q is likely to give a near-maximum value for g(p), ignoring the curvature of the lattice topology and all other lattice topologies. This estimate may be used if it is larger than v. This is shown schematically in FIG. 6.

### Marching the Sphere

If the shortcuts outlined above have not given a value for g(p), the sphere is marched in order to estimate its value. As an example, the flowchart of FIG. 7 illustrates the acts involved in a marching approach for estimating the maximum value over the sphere. The method 700 used in this approach begins, at act 702, with selecting thirteen seed positions qᵢ, twelve on the surface of the sphere at the vertices of an icosahedron and one at the center and marking them as requiring refining.

At act 704, for each sample qᵢ whose field value Gᵢ is unknown, Gᵢ=ƒ(qᵢ)−r is calculated, and the planar approximations of the lattice topologies are calculated, forming a set of planes Mᵢ. The value of g(p) is updated if it is larger than the current value. The method finishes if g(p)≥v.

For each sample qᵢ that requires refining, acts 706-710 are performed.

At act 706, a temporary set of planes A is set equal to Mᵢ, and a sphere is made centered at p with radius r.

At act 708, a point x is calculated to be the point on or in the sphere that maximizes the minimum signed distance to any plane in the supplied set A. This is done in a series of subacts, starting at act 708(i) with an empty subset of planes B, a solution x at the sphere center, and a solution distance d=∞:

At act 708(ii) of all the supplied planes not in the subset B (i.e., A\B), the plane with minimum signed distance to x is found. If this minimum distance is smaller than the current solution distance d, then at act 708(iii) the plane is added to subset B. If not, at act 708(iv) the current solution x is returned.

At act 708(v), x is discarded, and d is set to a value of −∞. If there is just one plane in B, at act 708(vi), the point on the sphere surface with maximum signed distance from this plane is found and stored as the new possible solution x and d is updated. If there is more than one plane in B, at act 708(vii) every pair, triplet, or quadruplet C of planes from B that contains the newest plane in B is determined, and for each subset C: (a) a point on or in the sphere that maximizes the minimum signed distance to any plane in C is found; and (b) if this distance is larger than the current solution distance d, and if this distance is smaller than the distance to any other plane in B (i.e. B\C), this point is stored as the new possible solution x and d is updated.

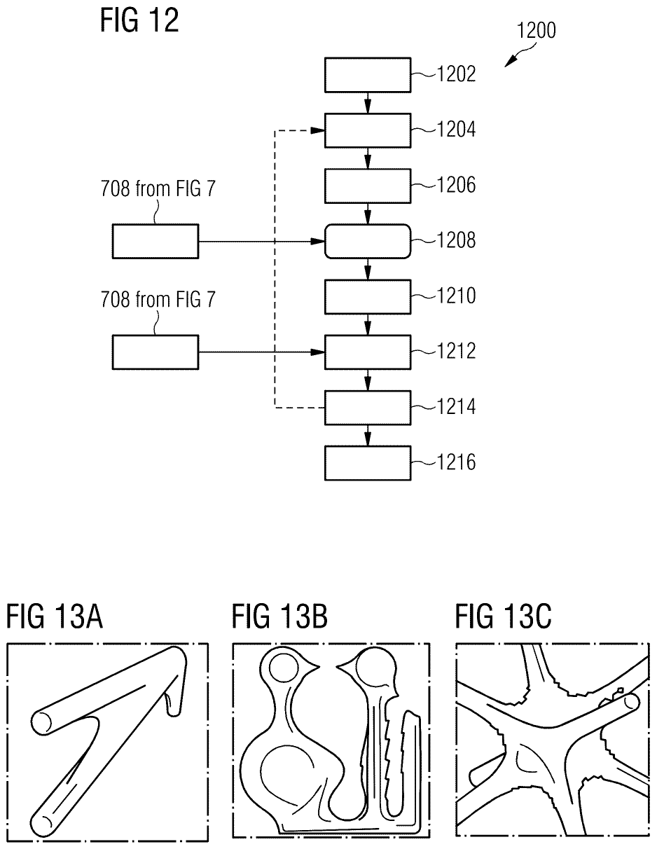

At act 708(viii), the process is repeated from act 708(ii) until act 708(iv) returns the solution x. Act 708 is used each time the marching process is used, with both a single concave blend and a double combination of a concave blend and a convex blend, as described below with reference to FIG. 12.

At act 710, the solution x found in act 708 is used as the new march act qᵢ. Eᵢ is set to the estimated value of ƒ(qᵢ)−r at the new march act. If qᵢ has not moved or if the expected increase in field value (Eᵢ−Gᵢ) is below 0.1v|∇g∥, where |∇g| is a value between 0 and 1 measuring how quickly g(p) increases as p moves, then no more refinement is necessary for this sample.

At act 712, if any sample qᵢ still requires refinement, acts 704 to 710 are repeated for a maximum of three iterations, although other numbers of iterations may be suitable for different lattice configurations. At act 714, for each sample qᵢ whose field value Gᵢ is unknown, Gᵢ=ƒ(qᵢ)−r is calculated, and g(p) is updated if a new maximum has been found.

### Variable Radius Blending

Variable-radius blending may be achieved by letting the blend radius be a function of position r(p). The blend radius at position p is given by:

$$r ( p ) = \{ \begin{matrix}\frac{{\sum }_{i = 1}^{N} {w}_{i} ( p ) {r}_{i} ( p )}{{\sum }_{i = 1}^{N} {w}_{i} ( p )} & if {w}_{i} ( p ) \neq 0 for some i \\ 0 & if {w}_{i} ( p ) = 0 for all i\end{matrix}$$

$$where :$$

$${w}_{i} ( p ) = \{ \begin{matrix}1 & if {f}_{i} ( p ) \leq 0 \\ 1 - \frac{{f}_{i} ( p )}{2 {r}_{i} ( p )} & if 0 < {f}_{i} ( p ) < 2 {r}_{i} ( p ) \\ 0 & if {f}_{i} ( p ) \geq 2 {r}_{i} ( p )\end{matrix}$$

where ƒ(p) is the signed distance of position p outside the surface of the lattice topology I, and r(p) is the blend radius of the lattice topology i.

Each blend radius may be specified for each lattice ball either absolutely or relative to the lattice ball's radius. Each lattice ball's blend radius r(p) is independent of the position p, whereas a lattice rod's blend radius is linearly interpolated from the blend radii of its two lattice balls. The interpolation is done by relaxing from position p to the lattice rod surface and using the proportional distance of the relaxed point along the lattice rod. Replacing the constant blend radius r in the acts outlined above with a variable blend radius r(p) affects the lower and upper bounds h_{lower}=h(p′)−∥p−p′∥, hᵤₚₚₑᵣ=h(p′)+∥p−p′∥ to account for the difference between r(p′) and r(p). As r(p) is not yet known, the minimum rₘᵢₙ and maximum rₘₐₓ blend radii of the lattice balls are used instead:

h_{lower}=h(p′)−max(∥p−p′∥,rₘₐₓ−r(p′)) if h_{lower}≥v

hᵤₚₚₑᵣ=h(p′)+max(∥p−p′∥,r(p′)−rₘᵢₙ) if hᵤₚₚₑᵣ≤−v

The spatial tree distance for finding all of the lattice topologies becomes 2rₘₐₓ+v, and the array of lattice topologies found is used to calculate r(p).

### Double-Blended Field Functions-Combined Concave and Convex Blends

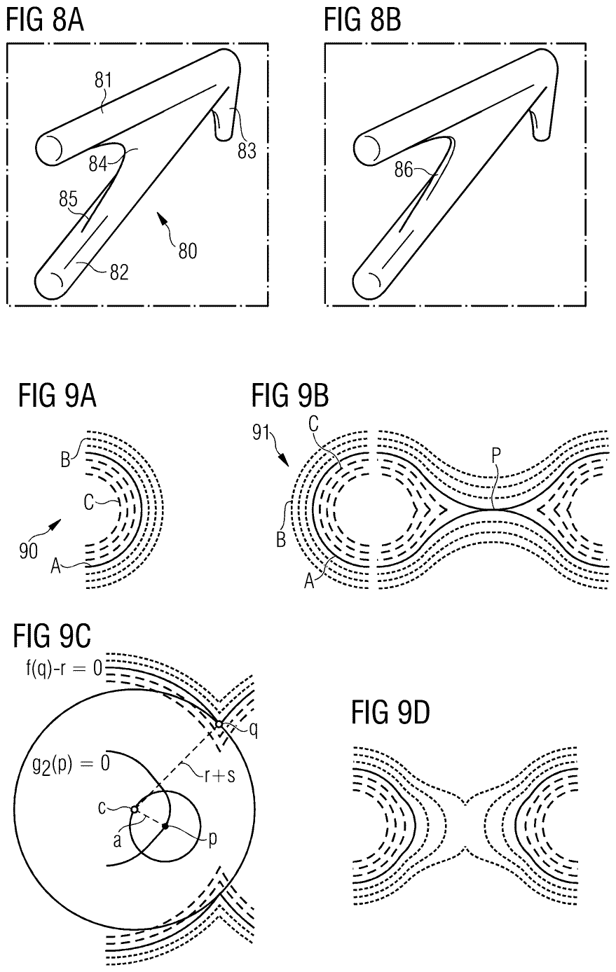

Having reviewed the background of blending where a single blend is used, an example of double blending in accordance with the embodiments of the present disclosure is shown in FIG. 8. This is where a concave blend is self-intersecting, creating a sharp edge which requires smoothing using a convex blend. FIG. 8a is a side perspective view of a portion of a lattice at which three rods meet at a ball. The portion of the lattice 80 illustrated includes a first rod 81 that connects to a second rod 82 and a third rod 83. In the region between the first 81 and second 82 rods a blend surface 84 has been created. However, whilst the blend surface 84 is itself a smooth concave blend, its boundary is a sharp edge 85. This is a result of using a large blend radius in the region of two rods meeting at an acute angle. The embodiments take the approach of combining the concave blend with a convex blend, as illustrated in FIG. 8b, where the concave blend surface 84 has been combined with a convex blend surface 86. This is described in further detail below.

Combining a concave and a convex blend results in a so-called double-blended field function, g₂(p):

$${g}_{2} ( p ) = {min}_{‖ c - p ‖ \leq s} ( {max}_{‖ q - c ‖ \leq r + s} ( f ( q ) - r ) )$$

where q is a position within the volume of a sphere of radius r+s centered at c and c is a position within the volume of a sphere of radius s centered at p.

In other words, the distance from a point q to the lattice offset outwards by r is found, and this value is maximized by moving q within a sphere centered at c with a radius r+s. This maximum is minimized by moving c within a sphere centered at p with a radius s. This is illustrated schematically in FIG. 9, which is an illustration of the blending of two balls using a method in accordance with embodiments of the present disclosure. In FIG. 9a, the unblended fields ƒ(p) for a first 90 and second 91 ball are shown, each having a zero-contour line A, positive contour lines B and negative contour lines C. The zero contour line A represents the points where ƒ(p)=0. In FIG. 9b, the blended field g(p) is shown, having a sharp convex point P in the center. FIG. 9c illustrates the construction of the double-blended field g₂(p). A point q lies on the circumference of a circle centered at c and having a radius r+s. The unblended field ƒ(q) at this point is equal to r, the radius of the concave blend, but the radius of the circle itself is r+s, where s is the blend radius of a convex blend represented by the smaller inner circle centered at p. The center c of the large circle lies on the circumference of the smaller inner circle centered at p. The double-blended field function g₂(p) is shown as an iso-surface at g₂(p)=0, and it is clear that the iso-surface is shaped by the combination of the concave and convex blends. FIG. 9d illustrates the final blend, resulting from the double-blended field function g₂(p) shown in FIG. 9c.

Calculating g₂(p) is slower than calculating either g(p) or ƒ(p), as it is necessary to find both c and q. Similar to the situation above, both ƒ(p) and g₂(p) have the same zero iso-surface away from any blends, so the faster ƒ(p) function may be used instead of g₂(p) in any calculations. Away from convex blends, both g(p) and g₂(p) have the same zero iso-surface, so that the faster g(p) may be used instead. Therefore, the piecewise field function of the blended lattice from above becomes:

h(p)=ƒ(p) if ƒ₁(p)≤−v;

h(p)=ƒ(p) if ƒ₂(p)≥2r+v;

h(p)=ƒ(p) if ƒ₁(p)+ƒ₂(p)≥2r and ƒ₁(p)≥v;

h(p)=g(p) if g(p)≥v;

h(p)=g(p) if g(p)≤−s and g(p)≤−v;

h(p)=g₂(p) otherwise;

Whilst h may not necessarily be the true distance to the blended lattice d, h|≤[d] is guaranteed, and h has the same sign as d. Within a distance v of the lattice surface, h is G⁰ continuous, and

$$0 < \frac{d h}{d d} < 1 .$$

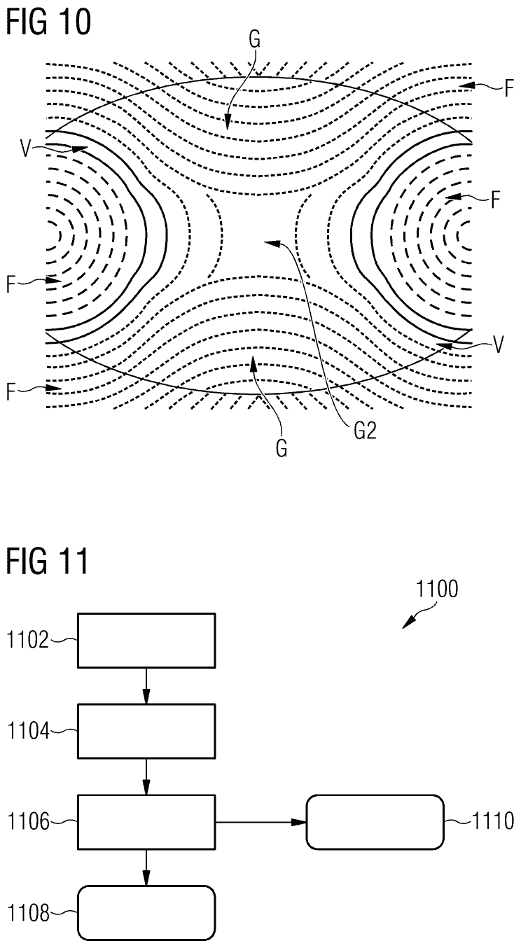

FIG. 10 illustrates the piecewise field function h(p) of the blended lattice. The piecewise field function h(p) includes ƒ(p) in the regions marked F, g(p) in the regions marked G and g₂(p) in the region marked G₂. The region lying within the voxel resolution of the blended lattice is marked V and contains no G⁰ discontinuities. The double-blended field function g₂(p) may be evaluated using a marching algorithm.

Embodiments of the present disclosure dealing with double-blended fields therefore take the approach of using a marching method to deal with the combination of a concave blend and a convex blend in lattice structures without adding bulging at lattice intersections.

FIG. 11 is a flowchart of a method in accordance with an embodiment of the present disclosure. The method 1100 generates a model of a component from a blended lattice, where the blended lattice includes a plurality of lattice topologies joined together.

At act 1102, the volume containing the input lattice is divided into a plurality of cubes, each cube (or “voxel”) having a side length v (the “voxel resolution”).

At act 1104, h(p) is evaluated uniformly over the volume for each value of a position p occurring at the corner of a cube, where h(p) is the piecewise scalar field function for a blended lattice. The surface of an unblended lattice is defined by a field function ƒ(p), the surface of a blended lattice for a concave blend is defined by a field function g(p) and the surface of a double-blended lattice for a combination of a concave blend and a convex blend is defined by a field function g₂(p), wherein away from any blends ƒ(p)=0, g₂(p)=0 are the same iso-surface and away from any convex blends g(p)=0 and g(p)=0 are the same iso-surface, and wherein the value of h(p) at a position p where for two closest lattice topologies i₁, i₂, ƒ₁(p) and ƒ₂(p) satisfy ƒ₁(p)≤ƒ₂(p) is given by:

h(p)=ƒ(p) if ƒ₁(p)≤−v;

h(p)=ƒ(p) if ƒ₂(p)≥2r+v;

h(p)=ƒ(p) if ƒ₁(p)+ƒ₂(p)≥2r and ƒ₁(p)≥v;

h(p)=g(p) if g(p)≥v;

h(p)=g(p) if g(p)≤−s and g(p)≤−v,

h(p)=g₂(p) otherwise;

where r is a concave blend radius and s is a convex blend radius.

At act 1106, a model of a component is generated including a blended lattice with the scalar field function h(p). The method 1100 may also include optional acts, depending on the purpose of the component.

At act 1108, the blended lattice may be incarnated as a mesh surface prior to generating the model of the component.

At act 1110, the model of the component may be exported to an additive manufacturing device and manufacturing the component.

### Estimating the Double-Blended Field Value by Marching the Sphere

As outlined above in connection with a single blend function, one exemplary manner in which the double-blended field function g₂(p) may be evaluated is by using a marching algorithm. This is illustrated in FIG. 12, which is a flow chart of a marching method of estimating the value over the sphere. If a non-zero convex blend radius is used, then g₂(p) is estimated in place of g(p) above, using a sphere radius of r+s instead of r. Both the position of the sample points qᵢ—to try to maximize g₂(p)—and the position of the sphere center c—to try to minimize the maximum—are refined. The method 1200 does this as follows.

At act 1202, sample positions qᵢ are set at thirteen seed positions (twelve on the surface of the sphere and one at the center), and marked as requiring refining, and the sphere center c is marked as requiring refining.

At act 1204, for each sample qᵢ whose field value Gᵢ is unknown, Gᵢ=ƒ(qᵢ)−r is calculated, and the planar approximations of the lattice topologies are calculated, forming a set of planes Mᵢ. The value of g₂(p) is updated if a new maximum has been found. The method finishes if g₂(p)≥v and if c does not need refining.

For each sample qᵢ that requires refining, acts 1206-1210 are performed.

At act 1206 a sphere is made centered at c with radius r+s.

At act 1208, act 708 is repeated with this sphere and with the set of planes Mᵢ as set A to find x.

At act 1210, the solution x found in act 1208 is used as the new march act qᵢ. Eᵢ is set to the estimated value of ƒ(qᵢ)−r at the new march act. If the sample qᵢ has not moved or if the expected increase in field value (Eᵢ−Gᵢ) is below 0.1v∥∇g∥, where ∥∇g∥ is a value between 0 and 1 measuring how quickly g(c) increases as c moves, then no more refinement is necessary for this sample.

At act 1212, if g₂(p)>−v and if c needs refining, a new sphere center c is calculated within a distance s of p. A plane is made at each sample qᵢ, tangential to the sphere and offset inwards by distance Eᵢ, forming a set of planes N. A sphere is made centered at p with radius s. Act 708 is repeated at this point with this sphere and the set of planes N as set A, as indicated in FIG. 12, and the solution x is used as the new sphere center c if it is further than 0.1v from the old sphere center. If the sphere center has moved, the samples qᵢ are translated by the change in sphere center, g₂(p) is discarded, along with all Gᵢ, and the samples qᵢ are marked as requiring refinement.

At act 1214, if any sample qᵢ still requires refinement, acts 1204 to 1212 are repeated for a maximum of eight iterations, marking the sphere center as not needing any more refinement for the final two iterations, although other numbers of iterations may be suitable for different lattice configurations.

At act 1216, for each sample qᵢ whose field value Gᵢ is unknown, Gᵢ=ƒ(qᵢ)−r is calculated, and g₂(p) is updated if a new maximum has been found.

Multiple marches from multiple seeds are used. This is partly to improve the chance of finding the global maximum rather than a local maximum, and partly so that each local maximum (if there is more than one) has an effect of the sphere center c. Between two symmetric lattice rods there are two local maxima, which are equal once c has converged. Between two symmetric lattice balls there is a single local maximum, which is a point that becomes a circular global maximum when c has converged. The convergence of the samples qᵢ is slow enough that c converges properly even though there is only ever a single maximum. In this example, and above, the number of seeds chosen is thirteen. This represents a number suitable for a large number of lattices, however, it may be possible to reduce or increase the number of seeds used in order to improve performance in some lattice configurations.

### Choosing the Convex Blend Radius

The convex blend radius s needs to be smaller than the radii of any nearby lattice topologies, otherwise the lattice topologies will disappear from the blended result and may also be smaller than the concave blend radius r in order to generate a sensible result. The estimation is done using a scaled value of the local radius of curvature, l(p). The local radius of curvature l(p) is given by:

$$l ( p ) = min ( \frac{{\sum }_{i = 1}^{N} {w}_{i} ( p ) {l}_{i} ( p )}{{\sum }_{i = 1}^{N} {w}_{i} ( p )} , {{min}_{1 \leq i \leq N}}_{{f}_{i} ( p ) \leq 0} {l}_{i} ( p ) )$$

$$where :$$

$${w}_{i} ( p ) = {\prod }_{j = 1}^{N} \{ \begin{matrix}1 if j = i \\ \vert \frac{1}{2 r ( p ) - {f}_{j} ( p )} - \frac{1}{2 r ( p )} \vert otherwise\end{matrix}$$

where ƒᵢ(p) is the signed distance of p outside the surface of the lattice topology i, and l; (p) is the radius of the lattice topology i or r(p), whichever is smaller.

Only lattice topologies that satisfy ƒᵢ(p)<2r(p) are included in the calculation. The radius of the lattice topology i, lᵢ(p) is a function of position p to take into account that rods may have a variable radius along their length. The inclusion of

$${{min}_{1 \leq i \leq n}}_{{f}_{i} ( p ) \leq 0} {l}_{i} ( p )$$

in the minimum above is required to avoid the radius of curvature being larger than the radius of any lattice topology that contains p (ƒᵢ(p)≤0), which would cause the containing lattice topologies to disappear from the blended result. This argument is also used when all values of w; (p) are zero.

The absolute value is used in the product above when ƒⱼ(p)<0, rather than using zero in place of the negative value, since this avoids all of the values for wᵢ(p) being zero when two or more ƒⱼ(p) are negative. This would correspond to p lying within two lattice topologies and would result in a discontinuity in l(p) when entering or leaving a second lattice topology of different radius. Using the absolute value, the discontinuity is restricted to the intersection of two different radius lattice topologies, but this is unlikely to be within the voxel resolution of the blend surface. If all lattice topologies have the same radius, or if they all have a radius greater than r(p), l(p) may be simplified to be equal to l₁(p). If the values of ƒᵢ(p) are all equal and positive, this simplifies to calculating the mean of lᵢ(p). On the surface of the lattice where only one value of ƒᵢ(p) is zero, l(p)=lᵢ(p). The local radius of curvature is then scaled to produce the convex blend radius:

s(p)=kl(p)

where k is a constant.

FIGS. 13 to 16 illustrate the effect of varying the value of k for different blends. FIG. 13 is an illustration of three different lattice configurations for which the value of k is zero. The blend in FIG. 13a is the lattice section shown in FIG. 8, the blend in FIG. 13b is a series of balls and rods, and the blend in FIG. 13c is a group of rods. No convex blend is generated for any of these lattices, such that in FIG. 13a, a sharp edge occurs at the concave blend, in FIG. 13b sharp points are generated on the balls and in FIG. 13c, sharp edges occur on each concave blend between each rod.

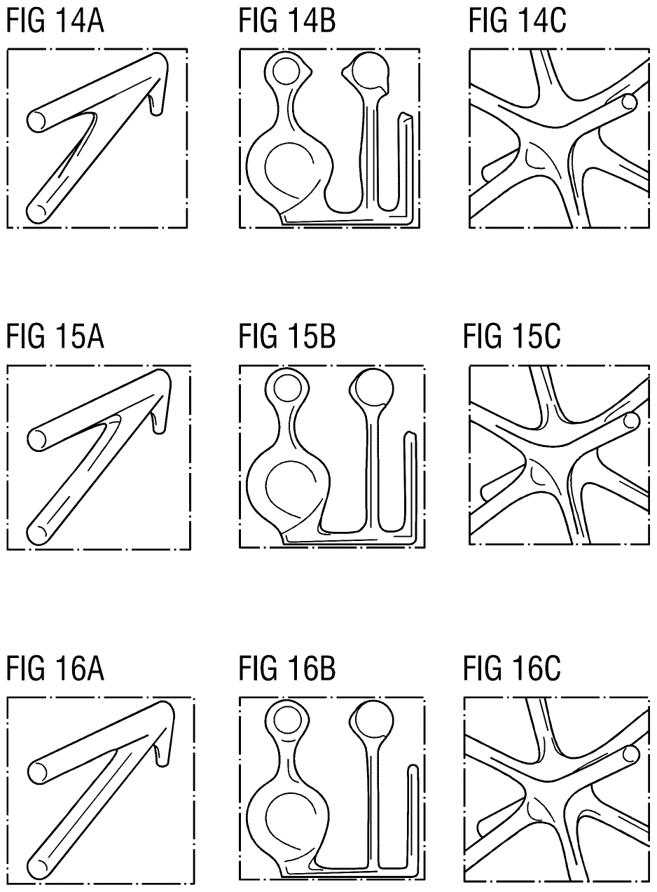

FIG. 14 is an illustration of the blends of FIG. 13 in which the value of k is ⅓. This results in a reasonable convex blend on the edge in FIG. 14a, but there are still tightly-curved regions occurring in FIGS. 14b and 14c.

FIG. 15 is an illustration of the blends of FIG. 13 in which the value of k is ⅔. In this example, FIG. 15a now displays a sharp concave edge where the convex blend is self-intersecting, however, the sharp points and edges have disappeared from FIGS. 15b and 15c.

FIG. 16 is an illustration of the blends of FIG. 13 in which the value of k is 0.95. In FIG. 16a, it appears as if no blending has occurred at all, which is the same in FIG. 16b in relation to the rods at the base of the lattice. FIG. 16c, however, still shows convex blending of the concave blends between the rods. After testing using various voxel sizes v, a value of k=⅔ was chosen as the scaling factor for the local radius l(p), since at certain voxel sizes the sharpness of edges on various lattice structures was either noticeably removed or not noticeable.

As above, where changing the concave blend radius r(p) affected the lower and upper bounds h_{lower}, hᵤₚₚₑᵣ, the same is true here for any change in the convex blend radius s(p):

min(Δh)=min(−∥Δp∥,−Δr,Δs) and

max(Δh)=max(∥Δp∥,−Δr,Δs)

As s(p) is not yet known the minimum sₘᵢₙ and maximum sₘₐₓ are used instead. Hence where a previous value of h(p), h(p′), has been calculated, h(p) may be set to a lower bound:

h_{lower}=h(p′)+min(−∥p−p′∥,r(p′)−rₘₐₓ,sₘᵢₙ−s(p′))

if h_{lower}≥v, or to an upper bound:

hᵤₚₚₑᵣ=h(p′)+max(∥p−p′∥,r(p′)−rₘᵢₙ,sₘₐₓ−s(p′))

if hᵤₚₚₑᵣ≤−v.

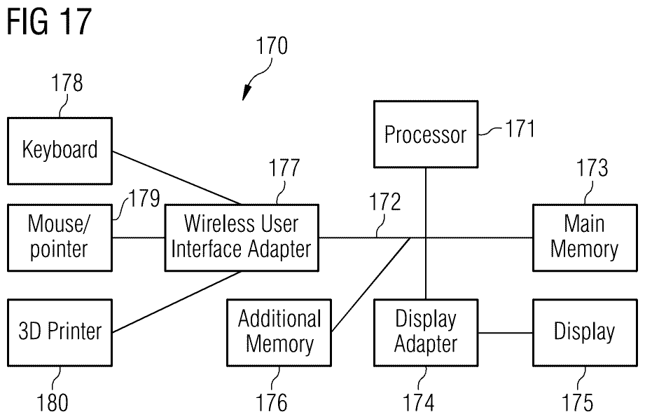

FIG. 17 illustrates an example of a data processing system in which an embodiment of the present disclosure may be implemented, for example, a CAD system configured to perform processes as described herein. The data processing system 170 includes a processor 171 connected to a local system bus 172. The local system bus connects the processor to a main memory 173 and graphics display adaptor 174, which may be connected to a display 175. The data processing system may communicate with other systems via a wireless user interface adapter connected to the local system bus 172, or via a wired network, for example, to a local area network. Additional memory 176 may also be connected via the local system bus. A suitable adaptor, such as wireless user interface adapter 177, for other peripheral devices, such as a keyboard 178 and mouse 179, or other pointing device, allows the user to provide input to the data processing system. An additive manufacturing device, such as a 3D printer 180 may be included to enable the model of the component to be exported for manufacture. Other peripheral devices may include one or more I/O controllers such as USB controllers, Bluetooth controllers, and/or dedicated audio controllers (connected to speakers and/or microphones). Various peripherals may be connected to the USB controller (via various USB ports) including input devices (e.g., keyboard, mouse, touch screen, trackball, camera, microphone, scanners), output devices (e.g., printers, speakers), or any other type of device that is operative to provide inputs or receive outputs from the data processing system. Further, certain devices referred to as input devices or output devices may both provide inputs and receive outputs of communications with the data processing system. Further, other peripheral hardware connected to the I/O controllers may include any type of device, machine, or component that is configured to communicate with a data processing system.

An operating system included in the data processing system enables an output from the system to be displayed to the user on display 175 and the user to interact with the system. Examples of operating systems that may be used in a data processing system may include Microsoft Windows™, Linux™, UNIX™, iOS™, and Android™ operating systems.

In addition, the data processing system 170 may be implemented as in a networked environment, distributed system environment, virtual machines in a virtual machine architecture, and/or cloud environment. For example, the processor 81 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system 170 may vary for particular implementations. For example, the data processing system 170 in this example may correspond to a computer, workstation, and/or a server. However, alternative embodiments of a data processing system may be configured with corresponding or alternative components such as in the form of a mobile phone, tablet, controller board or any other system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

The data processing system 170 may be connected to the network (not a part of data processing system 170), which may be any public or private data processing system network or combination of networks, as known to those of skill in the art, including the Internet. Data processing system 170 may communicate over the network with one or more other data processing systems such as a server (also not part of the data processing system 170). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, it is to be understood that when referring to a data processing system, such a system may be implemented across several data processing systems organized in a distributed system in communication with each other via a network.

The embodiments of the present disclosure provide blended lattices without the bulging at lattice intersections seen in existing blending applications. In addition, by using the shortcuts outlined above, the method is far quicker than if g₂(p) were to be evaluated for every cube voxel corner. Furthermore, using the double-blended field function g₂(p) removes any issues of sharp edges or points being created in the resulting blend by combining the concave rolling ball blend with a convex rolling ball blend.

1. A computer-implemented method of generating a model of a component from a blended lattice, wherein the blended lattice comprises a plurality of lattice topologies joined together, at least some of the joins being a combination of a concave blend and a convex blend, the method comprising:
dividing a volume containing an input lattice into a plurality of cubes, each cube forming a voxel of side length v;
evaluating h(p) over the volume for each value of a position p occurring at a corner of a cube, wherein h(p) is a piecewise scalar field function for a blended lattice, wherein a surface of an unblended lattice is defined by a field function ƒ(p), a surface of a blended lattice for a concave blend is defined by a field function g(p) and a surface of a double-blended lattice for a combination of a concave blend and a convex blend is defined by a field function g₂(p), wherein away from any blends ƒ(p)=0, g₂(p)=0 are a same iso-surface and away from any convex blends g(p)=0 and g₂(p)=0 are the same iso-surface, and wherein a value of h(p) at a position p, where for two closest lattice topologies i₁, i₂ of the plurality of lattice topologies, ƒ₁(p) and ƒ₂(p) satisfy ƒ₁(p)≤ƒ₂(p), is given by:
h(p)=ƒ(p) if ƒ₁(p)≤−v;
h(p)=ƒ(p) if ƒ₂(p)≥2r+v;
h(p)=ƒ(p) if ƒ₁(p)+ƒ₂(p)≥2r and ƒ₁(p)≥v;
h(p)=g(p) if g(p)≥v;
h(p)=g(p) if g(p)≤−s and g(p)≤−v; and
h(p)=g₂(p) otherwise,
where r is a concave blend radius and s is a convex blend radius; and
generating a model of a component comprising a blended lattice with the scalar field function h(p).

2. The computer-implemented method of claim 1, wherein each lattice topology i of the plurality of lattice topologies is a rod or a ball.

3. The computer-implemented method of claim 1, wherein the field function of the unblended lattice ƒ(p) is given by:
ƒ(p)=min [symbol] ₍1≤i≤N) [symbol] ƒ_i [symbol] (p)
where ƒᵢ(p) is a signed distance from the position p to a surface of a lattice topology i of the plurality of lattice topologies, and N is a number of lattice topologies in the blended lattice,
wherein the field function of the blended lattice g(p) is given by:
g(p)=max [symbol] _{(∥}q−p∥≤r)(ƒ(q)−r)
where q is a position within a volume of a sphere of radius r centered at p, and
wherein the field function of the double-blended lattice is given by:
g_2(p)=min [symbol] _{(|}c−p∥≤s)(max [symbol] _{(∥}q−c∥≤r+s)(ƒ(q)−r))
where q is a position within the volume of a sphere of radius r+s centered at c, and c is a position within a volume of a sphere of radius s centered at p.

4. The computer-implemented method of claim 3, wherein an evaluation of:
ƒ(p)=min [symbol] ₍1≤i≤N) [symbol] ƒ_i [symbol] (p)
is stopped at a value of i where ƒᵢ(p)≤−v, and
wherein an evaluation of:
g(p)=max [symbol] _{(∥}q−p∥≤r)(ƒ(q)−r)
is stopped at a value of q where ƒ(q)−r≥v.

5. The computer-implemented method of claim 4, wherein, when the value of h(p′) has already been calculated at a position p′, the value of h(p) is set to a lower bound:
h_lower=h(p\hat{ }′)+min(−∥p−p\hat{ }′∥,r(p\hat{ }′)−r_(max,)s_min−s(p\hat{ }′))ᵣ≥v,
or to an upper bound:
h_upper=h(p\hat{ }′)+max(∥p−p\hat{ }′∥,r(p\hat{ }′)−r_(min,)s_max−s(p\hat{ }′)≤−v.

6. The computer-implemented method of claim 3, wherein g(p) and the corresponding position q is determined exactly.

7. The computer-implemented method of claim 3, wherein g(p) and the corresponding position q is estimated.

8. The computer-implemented method of claim 3, wherein g(p) is estimated by marching over the sphere.

9. The computer-implemented method of claim 3, wherein g₂(p) is estimated by marching over the sphere.

10. The computer-implemented method of claim 1, wherein the blend radius r is constant over a lattice structure.

11. The computer-implemented method of claim 1, wherein the blend radius r is a function of the position p.

12. The computer-implemented method of claim 1, wherein the convex blend radius s is given by:
s(p)=kl(p)
where k is a constant and l(p) is a local radius of curvature.

13. The computer-implemented method of claim 1, further comprising:
incarnating the blended lattice as a mesh surface prior to generating the model of the component.

14. The computer-implemented method of claim 1, further comprising:
exporting the model of the component to an additive manufacturing device and manufacturing the component.

15. A data processing system configured to generate a model of a component from a blended lattice, wherein the blended lattice comprises a plurality of lattice topologies joined together, at least some joins being a combination of a concave blend and a convex blend, the data processing system comprising:
a processor configured to:
divide a volume containing an input lattice into a plurality of cubes, each cube forming a voxel of side length v;
evaluate h(p) over the volume for each value of a position p occurring at a corner of a cube, wherein h(p) is a piecewise scalar field function for a blended lattice; and
generate a model of a component comprising a blended lattice with the scalar field function h(p),
wherein a surface of an unblended lattice is defined by a field function ƒ(p), a surface of a blended lattice for a concave blend is defined by a field function g(p) and a surface of a double-blended lattice for a combination of a concave blend and a convex blend is defined by a field function g₂(p),
wherein away from any blends ƒ(p)=0, g₂(p)=0 are a same iso-surface and away from any convex blends g(p)=0 and g₂(p)=0 are the same iso-surface, and
wherein a value of h(p) at a position p, where for two closest lattice topologies i₁, i₂ of the plurality of lattice topologies, ƒ₁(p) and ƒ₂(p) satisfy ƒ₁(p)≤ƒ₂(p), is given by:
h(p)=ƒ(p) if ƒ₁(p)≤−v;
h(p)=ƒ(p) if ƒ₂(p)≥2r+v;
h(p)=ƒ(p) if ƒ₁(p)+ƒ₂(p)≥2r and ƒ₁(p)≥v;
h(p)=g(p) if g(p)≥v,
h(p)=g(p) if g(p)≤−s and g(p)≤−v; and
h(p)=g₂(p) otherwise,
where r is a concave blend radius and s is a convex blend radius.

16. The data processing system of claim 15,
further comprising:
an output to a three-dimensional printing device.

17. A computer program, which, when executed on a computer, causes the computer to; divide a volume containing an input lattice into a plurality of cubes, each cube forming a voxel of side length v;
evaluate h(p) over the volume for each value of a position p occurring at a corner of a cube, wherein h(p) is a piecewise scalar field function for a blended lattice, wherein a surface of an unblended lattice is defined by a field function ƒ(p), a surface of a blended lattice for a concave blend is defined by a field function (p) and a surface of a double-blended lattice for a combination of a concave blend and a convex blend is defined by a field function g₂(p), wherein away from any blends ƒ(p)=0, g₂(p)=0 are a same iso-surface and away from any convex blends g(p)=0 and g₂(p)=0 are the same iso-surface, and wherein a value of h(p) at a position p, where for two closest lattice topologies i₁, i₂ of a plurality of lattice topologies, ƒ₁(p) and ƒ₂(p) satisfy ƒ₁(p)≤ƒ₂(p), is given by:
h(p)=ƒ(p) if ƒ₁(p)≤−v;
h(p)=ƒ(p) if ƒ₂(p)≥2r+v;
h(p)=ƒ(p) if ƒ₁(p)+ƒ₂(p)≥2r and ƒ₁(p)≥v;
h(p)=g(p) if g(p)≥v;
h(p)=g(p) if g(p)≤−s and g(p)≤−v; and
h(p)=g₂(p) otherwise,
where r is a concave blend radius and s is a convex blend radius; and
generate a model of a component comprising a blended lattice with the scalar field function h(p).
